(19) United States
(12) Patent Application Publication
(10) Pub. No.: US 2024/0213525 A1
(43) Pub. Date: Jun. 27, 2024

(54) SOLID-STATE BATTERY

(71) Applicant: HONDA MOTOR CO., LTD., Tokyo (JP)

(72) Inventors: Takuya TANIUCHI, Saitama (JP); Toshimitsu TANAKA, Saitama (JP); Kizashi IWAKIRI, Saitama (JP)

(21) Appl. No.: 18/492,798

(22) Filed: Oct. 24, 2023

(30) Foreign Application Priority Data
Dec. 26, 2022 (JP) 2022-208442

(51) Int. Cl. H01M 10/0562; H01M 4/36; H01M 10/052; H01M 50/593

(52) U.S. Cl. CPC H01M 10/0562; H01M 4/364; H01M 10/052; H01M 50/593

(57) ABSTRACT

Provided is a solid-state battery including: an electrode laminate in which a negative electrode mixture layer, a solid electrolyte layer, and a positive electrode mixture layer are sequentially laminated over a negative electrode current collector; a positive electrode current collector; an insulating frame provided along an outer periphery of the positive electrode mixture layer and an outer periphery of the positive electrode current collector; and a positive electrode tab. In a cross section parallel to a laminating direction of the electrode laminate and perpendicular to a direction in which the positive electrode tab extends, the solid electrolyte layer has a first region disposed inside the insulating frame and a second region disposed outside the insulating frame, and when the solid-state battery is viewed from above, an outer peripheral edge of the second region is located outside an outer peripheral edge of the first region.

This application is based on and claims the benefit of priority from Japanese Patent Application 2022-208442, filed on 26 Dec. 2022, the content of which is incorporated herein by reference.

### BACKGROUND OF THE INVENTION

### Field of the Invention

The present invention relates to a solid-state battery.

### Related Art

In recent years, research and development of secondary batteries that contribute to energy efficiency has been carried out in order to ensure many people have access to reasonable, reliable, sustainable, and advanced energy.

Patent Document 1 discloses an all-solid-state battery including a positive electrode current collector layer, a first positive electrode active material layer laminated on a surface of the positive electrode current collector layer facing one side of the battery, a second positive electrode active material layer laminated on another surface of the positive electrode current collector layer facing the other side of the battery, a first solid electrolyte layer laminated on a surface of the first positive electrode active material layer facing the one side, a second solid electrolyte layer laminated on a surface of the second positive electrode active material layer facing the other side, a first negative electrode active material layer laminated on a surface of the first solid electrolyte layer facing the one side, a second negative electrode active material layer laminated on a surface of the second solid electrolyte layer facing the other side, a first negative electrode current collector layer laminated on a surface of the first negative electrode active material layer facing the one side, and a second negative electrode current collector layer laminated on a surface of the second negative electrode active material layer facing the other side. In the all-solid-state battery, the positive electrode current collector layer extends outward relative to the first negative electrode active material layer and the second negative electrode active material layer to thereby form an extension portion, and an insulating resin layer is continuously formed over a surface of the extension portion facing the one side, a side surface of the extension portion, and a surface of the extension portion facing the other side.

Patent Document 1: Japanese Unexamined Patent Application, Publication No. 2020-4697

### SUMMARY OF THE INVENTION

However, the all-solid-state battery disclosed in Patent Document 1 has a disadvantage that the strength thereof is insufficient.

In order to increase the strength of a solid-state battery, it is conceivable to dispose an insulating frame along the outer periphery of the solid-state battery, for example. In this case, it is desirable to stably dispose the insulating frame.

An object of the present invention is to provide a solid-state battery in which an insulating frame can be stably disposed.

A first aspect of the present invention is directed to a solid-state battery including: an electrode laminate in which a negative electrode mixture layer, a solid electrolyte layer, and a positive electrode mixture layer are sequentially laminated over a negative electrode current collector; a positive electrode current collector; an insulating frame provided along an outer periphery of the positive electrode mixture layer and an outer periphery of the positive electrode current collector; and a positive electrode tab extending from the positive electrode current collector. In a cross section parallel to a laminating direction of the electrode laminate and perpendicular to a direction in which the positive electrode tab extends, the solid electrolyte layer has a first region disposed inside the insulating frame and a second region disposed outside the insulating frame. When the solid-state battery is viewed from above, an outer peripheral edge of the second region is located outside an outer peripheral edge of the first region.

A second aspect of the present invention is an embodiment of the first aspect. In the solid-state battery according to the second aspect, when the solid-state battery is viewed from above, the outer peripheral edge of the first region is located at the same position as an outer peripheral edge of the positive electrode mixture layer or outside the outer peripheral edge of the positive electrode mixture layer, and the outer peripheral edge of the second region is located at the same position as an outer peripheral edge of the negative electrode mixture layer or outside the outer peripheral edge of the negative electrode mixture layer.

A third aspect of the present invention is an embodiment of the first or second aspect. In the solid-state battery according to the third aspect, the insulating frame has a communication hole.

A fourth aspect of the present invention is an embodiment of any one of the first to third aspects. In the solid-state battery according to the fourth aspect, the first region and the second region are bonded to each other by applying a solvent capable of dissolving a solid electrolyte constituting the solid electrolyte layer or a slurry containing the solid electrolyte.

A fifth aspect of the present invention is directed to a solid-state battery including: an electrode laminate in which a positive electrode mixture layer, a solid electrolyte layer, and a negative electrode mixture layer are sequentially laminated over a positive electrode current collector; a negative electrode current collector; an insulating frame provided along an outer periphery of the negative electrode mixture layer and an outer periphery of the negative electrode current collector; and a negative electrode tab extending from the negative electrode current collector. In a cross section parallel to a laminating direction of the electrode laminate and perpendicular to a direction in which the negative electrode tab extends, the solid electrolyte layer has a first region disposed inside the insulating frame and a second region disposed outside the insulating frame. When the solid-state battery is viewed from above, an outer peripheral edge of the second region is located outside an outer peripheral edge of the first region.

The present invention provides the solid-state battery in which the insulating frame can be stably disposed.

### BRIEF DESCRIPTION OF THE DRAWINGS

FIG. 1 is a top view illustrating an example of a solid-state battery according to an embodiment;

FIGS. 2A and 2B are cross-sectional views illustrating the solid-state battery of FIG. 1;

FIG. 3 is a cross-sectional view illustrating another example of the solid-state battery according to the embodiment;

FIGS. 4A, 4B, 4C, and 4D are schematic diagrams (Part 1) illustrating a method of manufacturing the solid-state battery of FIG. 1;

FIGS. 5A, 5B, 5C, 5D and 5E are schematic diagrams (Part 2) illustrating the method of manufacturing the solid-state battery of FIG. 1;

FIGS. 6A, 6B, 6C, and 6D are schematic diagrams (Part 3) illustrating the method of manufacturing the solid-state battery of FIG. 1; and

FIG. 7 is a cross-sectional view illustrating a modification of the solid-state battery of FIG. 1.

### DETAILED DESCRIPTION OF THE INVENTION

Embodiments of the present invention will be described with reference to the accompanying drawings.

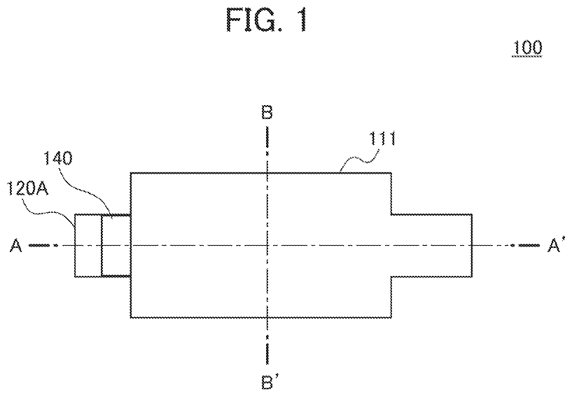

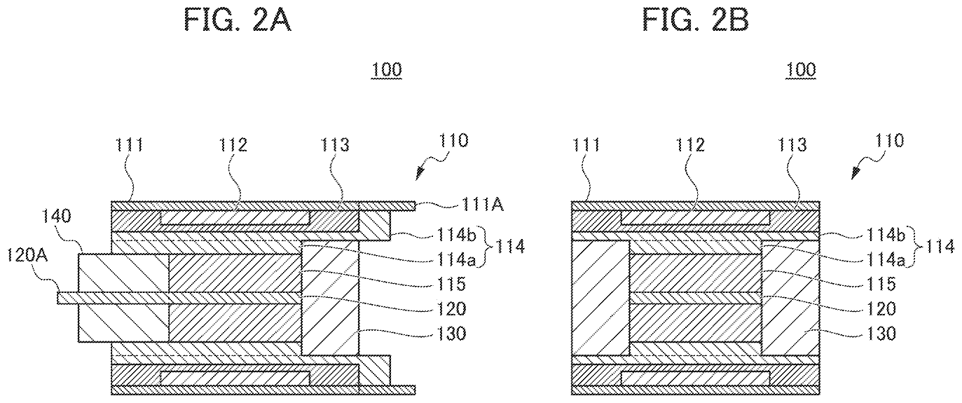

FIGS. 1, 2A, and 2B illustrate an example of a solid-state battery according to the present embodiment. FIGS. 2A and 2B are cross-sectional views taken along the A-A′ direction and the B-B′ direction of FIG. 1, respectively.

The solid-state battery 100 includes electrode laminates 110 in each of which a negative electrode mixture layer 112, an intermediate layer 113, a solid electrolyte layer 114, and a positive electrode mixture layer 115 are sequentially laminated over a negative electrode current collector 111, and a positive electrode current collector 120 sandwiched between the electrode laminates 110. The solid-state battery 100 has negative electrode tabs 111A extending from the negative electrode current collectors 111, and a positive electrode tab 120A extending from the positive electrode current collector 120. The direction in which the negative electrode tabs 111A extend is opposite to the direction in which the positive electrode tab 120A extends. The solid-state battery 100 further includes an insulating frame 130 disposed along an outer periphery of each of the positive electrode mixture layers 115 and an outer periphery of the positive electrode current collector 120. This configuration increases the strength of the solid-state battery 100. However, the insulating frame 130 is not disposed in an area where the positive electrode tab 120A extends from the positive electrode current collector 120, and an insulating layer 140 is formed in the area. As a result, the occurrence of a short circuit is prevented or reduced in the solid-state battery 100. In a cross section parallel to the laminating direction of the electrode laminates 110 and perpendicular to the direction in which the positive electrode tab 120A extends, i.e., a cross section taken along the B-B′ direction, the solid electrolyte layer 114 has a first region 114a disposed inside the insulating frame 130 and a second region 114b disposed outside the insulating frame 130.

Here, when the solid-state battery 100 is viewed from above, an outer peripheral edge of the second region 114b is located outside an outer peripheral edge of the first region 114a in a direction perpendicular to the direction in which the positive electrode tab 120A extends (see FIG. 2B). On the other hand, when the solid-state battery 100 is viewed from above, the outer peripheral edge of the second region 114b is located at the same position as the outer peripheral edge of the first region 114a in the direction in which the positive electrode tab 120A extends (see FIG. 2A). That is, when the solid-state battery 100 is viewed from above, the outer peripheral edge of the second region 114b is located outside the outer peripheral edge of the first region 114a. Due to this configuration, the insulating frame 130 is stably disposed, and as a result, the occurrence of stack displacement and one-side contact of the solid-state battery 100 are prevented or reduced.

In the present specification and the claims, the phrase “when the solid-state battery is viewed from above, an/the outer peripheral edge of the second region is located outside an/the outer peripheral edge of the first region” means that when the solid-state battery is viewed from above, at least part of the outer peripheral edge of the second region is located outside the outer peripheral edge of the first region, and the outer peripheral edge of the first region is not located outside the outer peripheral edge of the second region.

When the solid-state battery 100 is viewed from above, the outer peripheral edge of the second region 114b may be located outside the outer peripheral edge of the first region 114a in the direction in which the positive electrode tab 120A extends. In this case, when the solid-state battery 100 is viewed from above, the outer peripheral edge of the second region 114b may be located at the same position as the outer peripheral edge of the first region 114a in a direction perpendicular to the direction in which the positive electrode tab 120A extends.

When the solid-state battery 100 is viewed from above, the outer peripheral edge of the first region 114a is located at the same position as an outer peripheral edge of the positive electrode mixture layer 115 or outside the outer peripheral edge of the positive electrode mixture layer 115, and the outer peripheral edge of the second region 114b is located outside an outer peripheral edge of the negative electrode mixture layer 112 (see FIGS. 2A and 2B). This configuration prevents or reduces the occurrence of a short circuit in the solid-state battery 100.

When the solid-state battery 100 is viewed from above, the outer peripheral edge of the second region 114b may be located at the same position as the outer peripheral edge of the negative electrode mixture layer 112.

A material constituting the insulating frame 130 is not particularly limited as long as it has electron-insulating properties, and examples thereof include insulating oxides such as alumina, resins such as polyvinylidene fluoride (PVDF), rubbers such as styrene-butadiene rubber (SBR), etc.

The insulating frame 130 may have ion conductivity.

The insulating frame 130 may have communication holes. As will be described later, the communication holes make it easy to remove a solvent or a solvent contained in a slurry used for bonding the first region 114a to the second region 114b. In this case, the communication holes are preferably formed in a surface of the insulating frame 130 that is parallel to the direction in which the negative electrode tab 111A extends and the direction in which the positive electrode tab 120A extends.

Examples of the insulating frame 130 having the communication holes include a foam, a mesh, and the like.

A material constituting the insulating layer 140 is not particularly limited as long as it has electron-insulating properties, and examples thereof include resins such as polyvinylidene fluoride (PVDF), rubbers such as styrene-butadiene rubber (SBR), etc.

The insulating layer 140 may have ion conductivity.

When the solid-state battery 100 is viewed from above, an outer peripheral edge of the insulating layer 140 is located outside an outer peripheral edge of the solid electrolyte layer 114 adjacent to the side where the positive electrode tab 120A extends. In other words, the insulating layer 140 is in contact with a portion of the positive electrode tab 120A adjacent to the positive electrode current collector 120. As a result, the occurrence of a short circuit is prevented or reduced, and the strength of the solid-state battery 100 increases.

When the solid-state battery 100 is viewed from above, the outer peripheral edge of the first region 114a adjacent to the side where the positive electrode tab 120A extends may be located outside the outer peripheral edge of the second region 114b adjacent to the side where the positive electrode tab 120A extends. In this case, the outer peripheral edge of the insulating layer 140 is located outside the outer peripheral edge of the first region 114a adjacent to the side where the positive electrode tab 120A extends.

When the solid-state battery 100 is viewed from above, the outer peripheral edge of the insulating layer 140 may be located at the same position as the outer peripheral edge of the solid electrolyte layer 114 adjacent to the side where the positive electrode tab 120A extends.

When the solid-state battery 100 is viewed from above, the outer peripheral edge of the second region 114b adjacent to the side where the negative electrode tab 111A extends is located outside an outer peripheral edge of the negative electrode current collector 111. In other words, the second region 114b is in contact with a portion of the negative electrode tab 111A adjacent to the negative electrode current collector 111. This configuration increases the strength of the solid-state battery 100.

When the solid-state battery 100 is viewed from above, the outer peripheral edge of the second region 114b adjacent to the side where the negative electrode tab 111A extends may be located at the same position as the outer peripheral edge of the negative electrode current collector 111.

When the solid-state battery 100 is viewed from above, an outer peripheral edge of the intermediate layer 113 is located outside the outer peripheral edge of the negative electrode mixture layer 112, and is located at the same position as the outer peripheral edge of the negative electrode current collector 111. In other words, the intermediate layer 113 is in contact with an outer peripheral portion of the negative electrode current collector 111. This configuration prevents or reduces the occurrence of a short circuit.

When the solid-state battery 100 is viewed from above, the outer peripheral edge of the intermediate layer 113 may be located at the same position as the outer peripheral edge of the negative electrode mixture layer 112.

For example, in a case where the solid-state battery 100 is a lithium metal secondary battery, the intermediate layer 113 has a function of uniformly depositing the lithium metal.

As a result, the interface between the intermediate layer 113 and the solid electrolyte layer 114 is stabilized. Here, the lithium metal secondary battery may be an anode-free battery in which the negative electrode mixture layer 112 does not exist at the time of the first charge. In this case, after the first charge and the first discharge, a lithium metal layer as the negative electrode mixture layer 112 is formed.

A material constituting the intermediate layer 113 is not particularly limited, and examples thereof include carbon carrying a metal (for example, Ag, etc.) that can be alloyed with Li.

The electrode laminate 110 may be devoid of the intermediate layer 113 and/or the insulating layer 140, as necessary. The electrode laminates 110 sandwiching the positive electrode current collector 120 may be the same or different.

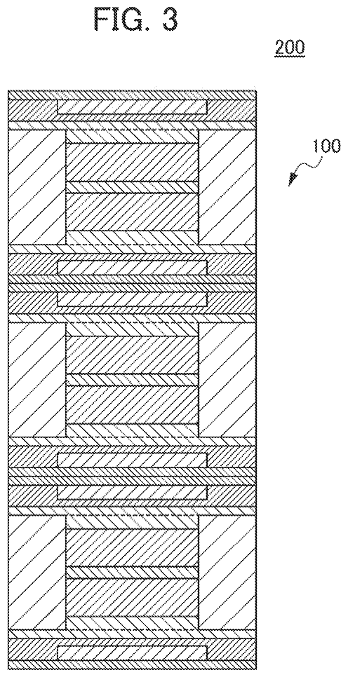

FIG. 3 illustrates another example of the solid-state battery according to the present embodiment.

The solid-state battery 200 includes a stack of a plurality of solid-state batteries 100, and the negative electrode current collector 111 belonging to each solid-state battery 100 is in contact with the negative electrode current collector 111 belonging to the adjacent solid-state battery 100.

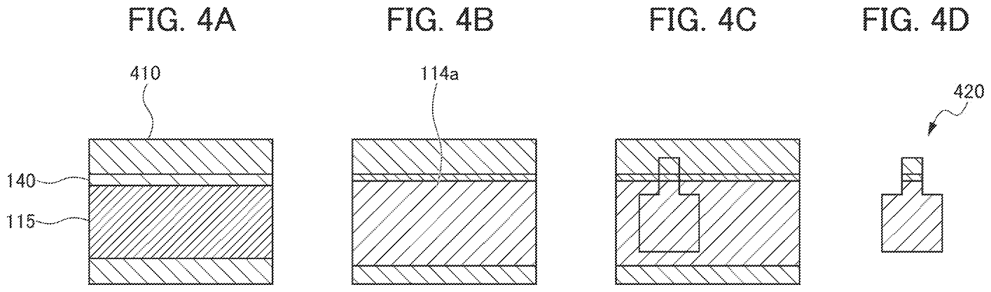

A method of manufacturing the solid-state battery 100 will be described with reference to FIGS. 4A to 6D.

First, a positive electrode mixture layer 115 and an insulating layer 140 are formed on a predetermined area of each of two opposite surfaces of a positive electrode current collector substrate 410 by a coating method (see FIG. 4A). Next, a first region 114a of a solid electrolyte layer 114 is formed, by a transfer method or a coating method, on a predetermined area of each surface of the positive electrode current collector substrate 410 having the positive electrode mixture layer 115 and the insulating layer 140 formed thereon (see FIG. 4B). Next, the resultant laminate is roll-pressed, and thereafter, a piece having a predetermined shape is punched out of the laminate (see FIG. 4C), thereby preparing a positive electrode-solid electrolyte laminate 420 (see FIG. 4D). This process makes it possible to control the shapes and dimensions of the end portions of the positive electrode-solid electrolyte laminate 420, whereby displacement of the positive electrode mixture layers 115 on the front and back surfaces of the positive electrode current collector 120 can be suppressed. Furthermore, adhesion between the positive electrode mixture layer 115 and the first region 114a is improved, and it becomes unlikely for the first region 114a to protrude.

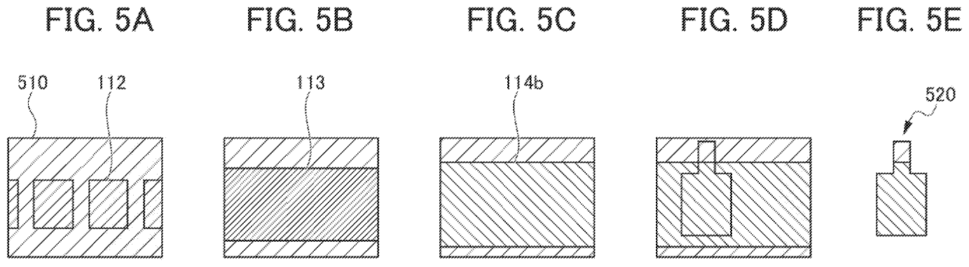

A negative electrode mixture layer 112 is formed on predetermined areas of one surface of a negative electrode current collector substrate 510 by a coating method (see FIG. 5A). Next, an intermediate layer 113 is formed, by a transfer method or a coating method, on a predetermined area of the negative electrode current collector substrate 510 having the negative electrode mixture layer 112 formed thereon (see FIG. 5B). Next, a second region 114b of the solid electrolyte layer 114 is formed, by a transfer method or a coating method, on a predetermined area of the negative electrode current collector substrate 510 having the intermediate layer 113 formed thereon (see FIG. 5C). Next, the resultant laminate is roll-pressed, and thereafter, a piece having a predetermined shape is punched out of the laminate (see FIG. 5D), thereby preparing a negative electrode-intermediate layer-solid electrolyte laminate 520 (see FIG. 5E). This process makes it unlikely for the negative electrode mixture layer 112 and the second region 114b to be in contact with each other, and reduces or prevents detachment of the intermediate layer 113. Furthermore, adhesion between the negative electrode mixture layer 112, the intermediate layer 113, and the second region 114b is improved, and it becomes unlikely for the intermediate layer 113 and the second region 114b to protrude.

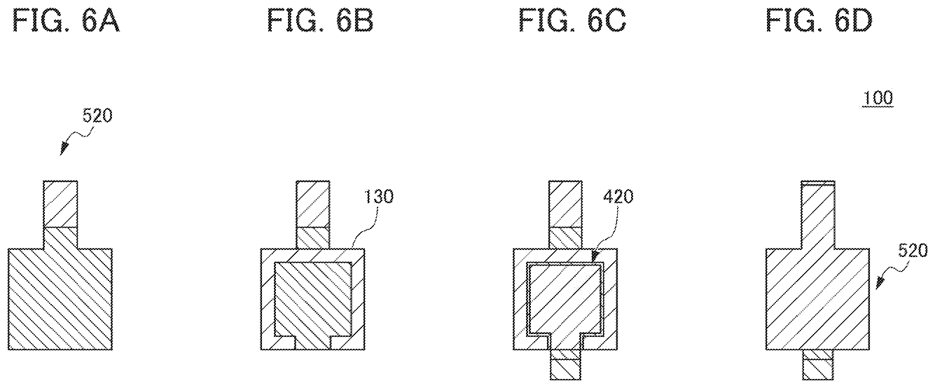

At a predetermined position on the negative electrode-intermediate layer-solid electrolyte laminate 520 (see FIG. 6A), an insulating frame 130 is disposed (see FIG. 6B). Next, the positive electrode-solid electrolyte laminate 420 is disposed at a predetermined position on the negative electrode-intermediate layer-solid electrolyte laminate 520 having the insulating frame 130 disposed thereon, such that the first region 114a and the second region 114b of the solid electrolyte layer 114 face each other (see FIG. 6C). Next, another negative electrode-intermediate layer-solid electrolyte laminate 520 is disposed at a predetermined position over the negative electrode-intermediate layer-solid electrolyte laminate 520 having the insulating frame 130 and the positive electrode-solid electrolyte laminate 420 disposed thereon, such that the first region 114a and the second region 114b of the solid electrolyte layer 114 face each other.

Thereafter, the resultant laminate is subjected to uniaxial pressing, thereby producing a solid-state battery 100 (see FIG. 6D).

Here, in the step of disposing the positive electrode-solid electrolyte laminate 420 (see FIG. 6C) and in the step of disposing the negative electrode-intermediate layer-solid electrolyte laminate 520 (see FIG. 6D), a solvent capable of dissolving the solid electrolyte constituting the solid electrolyte layer 114 or a slurry containing the solid electrolyte constituting the solid electrolyte layer 114 is applied to a surface of the first region 114a and/or a surface of the second region 114b. As a result, the first region 114a and the second region 114b are bonded to each other, whereby the interface resistance decreases. In order to remove the solvent used for bonding the first region 114a to the second region 114b or the solvent contained in the slurry, heating and drying may be performed as needed. The heating and drying may be performed before or after the uniaxial pressing. For example, the heating and drying may be performed after the solid-state battery 100 is constrained with an end plate. As a result, the occurrence of stack displacement and one-side contact of the solid-state battery 100 are prevented or reduced.

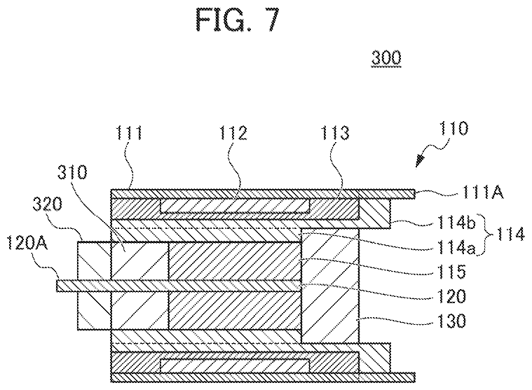

FIG. 7 illustrates a modification of the solid-state battery 100. FIG. 7 is a cross-sectional view taken along a direction corresponding to the A-A′ direction in FIG. 1.

The solid-state battery 300 has the same configuration as that of the solid-state battery 100 except that a solid electrolyte layer 310 and an insulating tape 320 attached to an outer periphery of the solid electrolyte layer 310 are provided in place of the insulating layer 140.

When the solid-state battery 300 is viewed from above, an outer peripheral edge of the solid electrolyte layer 310 is located at the same position as an outer peripheral edge of the solid electrolyte layer 114 adjacent to the side where the positive electrode tab 120A extends.

When the solid-state battery 300 is viewed from above, the outer peripheral edge of the solid electrolyte layer 310 may be located outside the outer peripheral edge of the solid electrolyte layer 114 adjacent to the side where the positive electrode tab 120A extends. In this case, the insulating tape 320 does not have to be attached to the outer periphery of the solid electrolyte layer 310.

A material constituting the solid electrolyte layer 310 may be the same as or different from a material constituting the solid electrolyte layer 114.

A material constituting the insulating tape 320 is not particularly limited as long as it has electron-insulating properties, and examples thereof include resins such as polyimide, etc. Examples of a commercially available polyimide film for constituting the insulating tape 320 include Kapton® (manufactured by DU PONT-TORAY CO., LTD.) and the like.

The insulating tape 320 may have ion conductivity.

In the following, a case where the solid-state battery of the present embodiment is an all-solid-state lithium secondary battery will be described.

The positive electrode current collector is not particularly limited, and examples thereof include an aluminum foil and the like.

The positive electrode mixture layer contains a positive electrode active material, and may further contain a solid electrolyte, a conductive auxiliary agent, a binder, and the like.

The positive electrode active material is not limited to any particular material as long as the positive electrode active material is capable of occluding and releasing lithium ions, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, and the like.

The solid electrolyte constituting the solid electrolyte layer is not particularly limited as long as the solid electrolyte is capable of conducting lithium ions, and examples thereof include an oxide electrolyte, a sulfide electrolyte, etc.

The solvent capable of dissolving the solid electrolyte is not particularly limited, and examples thereof include butyl butyrate, etc. The solvent for use in the slurry containing the solid electrolyte is not particularly limited, and examples thereof include butyl butyrate, etc.

The negative electrode mixture layer contains a negative electrode active material, and may further contain a solid electrolyte, a conductive auxiliary agent, a binder, and the like.

The negative electrode active material is not particularly limited as long as the negative electrode active material is capable of occluding and releasing lithium ions, and examples thereof include metallic lithium, a lithium alloy, a metal oxide, a metal sulfide, a metal nitride, Si, SiO, a carbon material, etc. Examples of the carbon material include artificial graphite, natural graphite, hard carbon, soft carbon, etc.

The negative electrode current collector is not particularly limited, and examples thereof include a copper foil and the like.

It should be noted that the present invention is not limited to the embodiments described above, and the embodiments described above may be appropriately modified without deviating from the spirit of the present invention. For example, the positions of the positive electrode and the negative electrode may be exchanged in the solid-state battery. In this case, the solid-state battery includes an electrode laminate in each a positive electrode mixture layer, a solid electrolyte layer, and a negative electrode mixture layer are sequentially laminated over a positive electrode current collector, a negative electrode current collector, and an insulating frame provided along an outer periphery of the negative electrode mixture layer and an outer periphery of the negative electrode current collector. In a cross section parallel to the limiting direction of the electrode laminate and perpendicular to the direction in which a negative electrode tab extends, the solid electrolyte layer has a first region disposed inside the insulating frame and a second region disposed outside the insulating frame.

### DETAILED DESCRIPTION OF THE INVENTION

100, 200: Solid-state battery
110: Electrode laminate
111: Negative electrode current collector
111A: Negative electrode tab
112: Negative electrode mixture layer
113: Intermediate layer
114: Solid electrolyte layer
114a: First region
114b: Second region
115: Positive electrode mixture layer
120: Positive electrode current collector
120A: Positive electrode tab
130: Insulating frame
140: Insulating layer
310: Solid electrolyte layer
320: Insulating tape
410: Positive electrode current collector substrate
420: Positive electrode-solid electrolyte laminate
510: Negative electrode current collector substrate
520: Negative electrode-intermediate layer-solid electrolyte laminate

What is claimed is:

1. A solid-state battery comprising:
an electrode laminate in which a negative electrode mixture layer, a solid electrolyte layer, and a positive electrode mixture layer are sequentially laminated over a negative electrode current collector;
a positive electrode current collector;
an insulating frame provided along an outer periphery of the positive electrode mixture layer and an outer periphery of the positive electrode current collector; and
a positive electrode tab extending from the positive electrode current collector, wherein
in a cross section parallel to a laminating direction of the electrode laminate and perpendicular to a direction in which the positive electrode tab extends, the solid electrolyte layer has a first region disposed inside the insulating frame and a second region disposed outside the insulating frame, and
when the solid-state battery is viewed from above, an outer peripheral edge of the second region is located outside an outer peripheral edge of the first region.

2. The solid-state battery according to claim 1, wherein
when the solid-state battery is viewed from above, the outer peripheral edge of the first region is located at the same position as an outer peripheral edge of the positive electrode mixture layer or outside the outer peripheral edge of the positive electrode mixture layer, and the outer peripheral edge of the second region is located at the same position as an outer peripheral edge of the negative electrode mixture layer or outside the outer peripheral edge of the negative electrode mixture layer.

3. The solid-state battery according to claim 1, wherein
the insulating frame has a communication hole.

4. The solid-state battery according to claim 1, wherein
the first region and the second region are bonded to each other by applying a solvent capable of dissolving a solid electrolyte constituting the solid electrolyte layer or a slurry containing the solid electrolyte.

5. A solid-state battery comprising:
an electrode laminate in which a positive electrode mixture layer, a solid electrolyte layer, and a negative electrode mixture layer are sequentially laminated over a positive electrode current collector;
a negative electrode current collector;
an insulating frame provided along an outer periphery of the negative electrode mixture layer and an outer periphery of the negative electrode current collector; and
a negative electrode tab extending from the negative electrode current collector, wherein
in a cross section parallel to a laminating direction of the electrode laminate and perpendicular to a direction in which the negative electrode tab extends, the solid electrolyte layer has a first region disposed inside the insulating frame and a second region disposed outside the insulating frame, and
when the solid-state battery is viewed from above, an outer peripheral edge of the second region is located outside an outer peripheral edge of the first region.
